(19) United States
(12) Patent Application Publication
(10) Pub. No.: US 2023/0303234 A1
(43) Pub. Date: Sep. 28, 2023

(54) MARINE TILLER FOR A RUDDER

(71) Applicant: VOLVO PENTA CORPORATION, Göteborg (SE)

(72) Inventor: Thorbjörn LUNDQVIST, Västra Frölunda (SE)

(73) Assignee: VOLVO PENTA CORPORATION, Göteborg (SE)

(21) Appl. No.: 18/181,166

(22) Filed: Mar. 9, 2023

(30) Foreign Application Priority Data
Mar. 23, 2022 (EP) 22163807.5

(51) Int. Cl. B63H 25/10; B63H 21/17; B63H 21/21

(52) U.S. Cl. CPC B63H 25/10; B63H 21/17; B63H 21/213; B63H 2021/216; F03B 13/10

(57) ABSTRACT

A tiller for controlling a rudder of a sailboat comprising a handle arranged to be controlled by one hand. The handle is provided with a plurality of engagement positions, where a first engagement position is adapted to engage a forward drive mode of an electric drive system, a second engagement position is adapted to engage a reverse drive mode of the electric drive system, a third engagement position is adapted to engage an idle drive mode of the electric drive system, and a fourth engagement position is adapted to engage a hydro energy generation mode of the electric drive system.

### TECHNICAL FIELD

The present invention relates to a marine tiller arranged to control a rudder on a marine sailboat, where the sailboat is provided with an electric drive system.

### BACKGROUND ART

Electric propulsion of vehicles is getting more and more common in order to replace combustible fuels. Slowly, electrical propulsion of marine vehicles are also gaining more interest. Electrical drive systems for slower boats, such as gigs or sailboats, are relatively energy efficient when the boat travels at low speeds. A further advantage for sailboats is that they normally do not need the motor, and that the motor is mostly used in emergencies and when docking. In such cases, an electric drive may be plausible.

Smaller sailboats are controlled or steered by a tiller connected to a rudder at the rear or stern of the sailboat. The tiller may be directly connected to the rudder, or through a transmission or the like, depending on the size of the sailboat and the type of rudder. If a sailboat is to be propelled by a combustion engine, the speed and the direction of the engine is controlled by a separate lever, and the sailboat is steered by the tiller/rudder combination.

Some sailboats are also provided with an electric motor that can propel the sailboat in a forward or reverse direction, e.g. when docking or when there is no or little wind blowing. Such a motor is also controlled with a separate lever.

Smaller outboard engines, both combustion engines and electric motors, are provided with a handle to steer the engine or motor. The handle is provided with a rotational control mechanism that can control the speed of the motor. On some electric motors, the control mechanism is provided with a central idle position in which the engine is shut off, and where a rotation in one direction will drive the motor in a forward direction and a rotation in the other direction will drive the motor in a reverse direction.

US20080207065 describes an electric outboard motor provided with a handle having several functions to control the motor. US20040152373 describes an electric drive system for a sailboat, where a switch device is used to control the different operation modes of the electric drive system.

These systems functions well for their intended use. There is still room for an improved tiller for a sailboat.

### DISCLOSURE OF INVENTION

An object of the invention is therefore to provide an improved tiller for a sailboat. A further object of the invention is to provide an electric drive system for a sailboat comprising such a tiller. A further object of the invention is to provide a method for controlling an electric drive system of a sailboat. A further object of the invention is to provide a sailboat comprising such a tiller.

The solution to the problem according to the invention is defined by the features of the main claims. The other claims contain advantageous further developments of the tiller and the method.

In a tiller for controlling a rudder of a sailboat comprising a handle arranged to be controlled by one hand, where the handle is provided with a plurality of engagement positions, where a first engagement position is adapted to engage a forward drive mode of an electric drive system, a second engagement position is adapted to engage a reverse drive mode of the electric drive system, a third engagement position is adapted to engage an idle drive mode of the electric drive system, the object of the invention is achieved in that a fourth engagement position is adapted to engage a hydro energy generation mode of the electric drive system.

By this first embodiment of the tiller for a sailboat, a person can control the different drive modes of the electric drive system of the sailboat with one hand by moving the handle to different positions, and at the same time be able to steer the sailboat by adjusting the rudder angle. The different engagement positions will control an electric drive system comprising an electric machine that is drivingly connected to a propeller of the sailboat. An electronic control unit (ECU) receives control signals from the handle of the tiller and controls the electric machine. The control signals may be sent to the ECU through a wire or through wireless communication.

In the first engagement position, the forward drive mode is engaged, which will rotate the propeller in a forward direction. In the second engagement position, the reverse drive mode is engaged, which will rotate the propeller in a reverse direction. In the third engagement position, the neutral or idle drive mode is engaged, in which the electric machine either rotates the propeller with a rotational speed corresponding to the speed of the sailboat, or in which the electric machine is disconnected from the propeller, such that the propeller will not induce any drag to the sailboat. In the fourth engagement position, the hydro energy generation mode is engaged, in which the electric machine is rotated by the propeller such that the electric machine generates electricity to charge the battery.

The tiller comprises a handle mounted at the front part of the tiller. The handle is longitudinal and can be rotated around the tiller shaft in order to engage different drive modes of the electric drive system. The handle is in one example 10-12 cm long such that it can easily be operated by the hand of a person. The diameter may be in the range of 3-6 cm. The first engagement position, the second engagement position and the third engagement position are controlled by the handle when the handle is in an intermediate longitudinal position on the tiller shaft. The third engagement position is an intermediate position from which the first engagement position is reached by rotating the handle in a first, e.g. clockwise direction, and from which the second engagement position is reached by rotating the handle in a second, e.g. counter-clockwise direction.

The handle can further be moved forwards and/or backwards on the tiller shaft in order to engage e.g. a locking position or the fourth engagement position of the tiller. The tiller is in one example provided with a locking position in which the different drive modes cannot be changed. In the locking mode, all drive modes may be disengaged or the last used handle position may be preserved and locked. The locking position is in one example reached by moving the handle in a second longitudinal direction, e.g. forwards, on the tiller, i.e. towards the bow of the sailboat. The handle is also provided with a fourth engagement position in which the electric machine generates electricity to charge the battery. The fourth engagement position is in one example reached by moving the handle in a first longitudinal direction, e.g. backwards on the tiller, i.e. towards the stern of the sailboat. In the fourth engagement position, engaging the hydro energy generation mode, all drive modes are disabled.

The tiller will be used at the rear or stern of a sailboat and is connected to a rudder arranged to steer the sailboat. The rudder may be positioned at the stern of the sailboat, where the tiller is connected directly to the rudder. The rudder may also be positioned underneath the sailboat, with the tiller being connected to the rudder either directly or through a transmission of some kind. The main travel direction of the sailboat is forwards, i.e. travelling in the direction in which the bow points. In a reverse direction, the sailboat will travel in the direction of the stern.

When the handle is in the intermediate longitudinal position and is not turned in any direction, the idle drive mode will be engaged. In the idle drive mode, the electric drive system will be neutral and will not affect the speed of the sailboat. In one example, this is achieved by rotating the propeller with a rotational speed that corresponds to the speed of the sailboat, such that the propeller does not induce any additional drag on the sailboat. By using this type of idle drive mode, the electric machine is always connected and ready to drive the sailboat forwards or rearwards at e.g. an emergency. Further, this allows for the use of a fixed propeller without the normal drawbacks of a fixed propeller, i.e. induced drag. It is also possible to place the electric drive system in the idle drive mode by disconnecting the electric machine from the propeller by the use of a clutch, either mechanical or electrical. With the electric machine disconnected from the propeller, the propeller can rotate freely and will induce a minimal drag.

In the method for engaging an electric drive system of a sailboat in different drive modes, where the drive modes are set by the use of a handle arranged on a tiller, the steps of; engaging the electric drive system in an idle drive mode when the handle is in a third engagement position; engaging the electric drive system in a forward drive mode by rotating the handle in a first direction from the third engagement position; engaging the electric drive system in a reverse drive mode by rotating the handle in a second direction from the third engagement position; and engaging the electric drive system in a hydro energy generation mode by moving the handle in a longitudinal direction on the tiller are disclosed.

### BRIEF DESCRIPTION OF DRAWINGS

The invention will be described in greater detail in the following, with reference to the attached drawings, in which

FIG. 1 shows a schematic sailboat provided with an electric drive system according to the invention,

FIG. 2 shows a front view of a tiller with a handle,

FIG. 3a-c shows different longitudinal positions of a handle, and

FIG. 4 shows a schematic flow chart of the inventive method.

### MODES FOR CARRYING OUT THE INVENTION

The embodiments of the invention with further developments described in the following are to be regarded only as examples and are in no way to limit the scope of the protection provided by the patent claims.

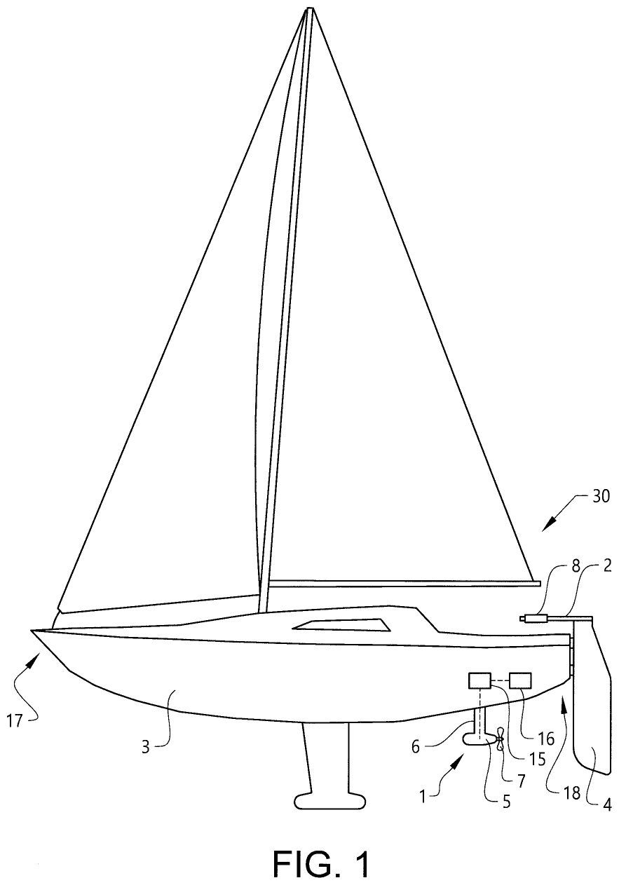

FIG. 1 shows a schematic sailboat 30 provided with an electric drive system 1 for propelling the sailboat or for generating electric energy. The electric drive system 1 comprises a drive unit 6 comprising an electric machine 5 that is drivingly connected to a propeller 7. The drive unit 6 is mounted on the bottom of the boat, under the hull 3. The electric machine is in the shown example arranged at the lower part of the drive unit. The electric machine may also be arranged inside the hull and may be connected to the propeller through a transmission. The propeller is preferably a fixed, non-foldable propeller. The electric drive system also comprises an electronic control unit (ECU) 15 and a battery 16. The ECU controls the electric drive system.

The sailboat 30 is provided with a bow 17 arranged at the front of the sailboat and a stern 18 arranged at the rear of the sailboat. A forward travel direction is the normal travel direction of the sailboat and is the direction in which the bow points. A reverse direction is a direction in which the stern points. The tiller will be arranged at the rear of the sailboat and will point forwards towards the bow when the sailboat sails straight.

The sailboat comprises a tiller 2 connected to a rudder 4 that is arranged to steer the sailboat. The sailboat is a relatively small sailboat, up to around 10 meters or more, where the direction of the sailboat is controlled by the tiller. Larger sailboats are provided with one or more steering wheels arranged to steer the sailboat. The tiller comprises a handle 8 that is provided with different engagement positions. The use of a handle at the front part of the tiller allows a person to control the different drive modes and the regeneration mode of the electric drive system of the sailboat with one hand, and at the same time being able to steer the sailboat by adjusting the rudder direction. The different drive modes and the generation mode are set by moving the handle to different positions. The handle will send control signals to the ECU depending on the actual engagement position of the handle, such that the ECU will be able to control the electric drive system. The control signals may be sent to the ECU through a wire or through wireless communication.

In the shown example, the handle can be rotated and can be set in three longitudinal positions. FIG. 3 shows the three longitudinal positions, where FIG. 3a shows the handle 8 in an intermediate position 14, FIG. 3b shows the handle in a second, e.g. forward, position corresponding to a locking position 13, where the handle has been moved forwards towards the bow from the intermediate position. FIG. 3c shows the handle in a first, e.g. rearward position corresponding to a fourth engagement position 12, where the handle has been moved backwards towards the stern from the intermediate position. In the intermediate position 14, the handle can be rotated in a clockwise or a counter-clockwise direction from the third engagement position.

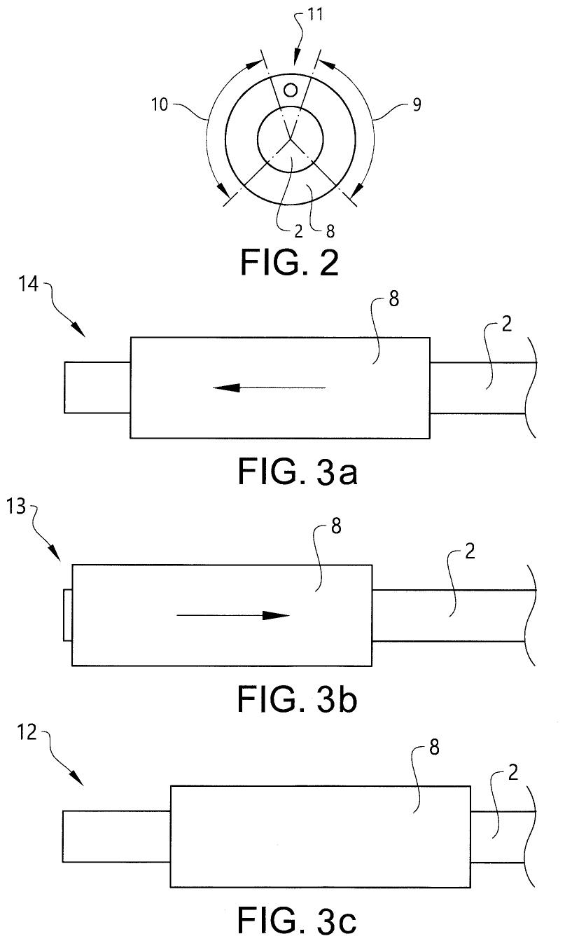

FIG. 2 shows an example of a handle 8 in the intermediate position 14. The handle is seen from the front of the tiller. In this example, the handle 8 can be set in a first engagement position 9, a second engagement position 10 and in a third engagement position 11. The third engagement position 11 is a mid position where the handle is in an idle, not rotated position. The third engagement position sets the electric drive system in a neutral or idle drive mode, in which the propeller will not induce any or minimal drag to the sailboat and in which the propeller does not affect the speed of the sailboat.

In one example, this is achieved by rotating the propeller with a rotational speed that corresponds to the speed of the sailboat, such that the propeller does not induce any additional drag on the sailboat. By using this type of idle drive mode, the electric machine is always connected and ready to drive the sailboat forwards or backwards at e.g. an emergency. It is also possible to disconnect the electric machine from the propeller with a clutch.

The tiller 2 comprises a handle 8 mounted at the front part of the tiller. The handle can be rotated around the tiller shaft in order to engage different drive modes of the electric drive system. The first engagement position, the second engagement position and the third engagement position are controlled by rotating the handle when the handle is in an intermediate longitudinal position on the tiller shaft. The handle can be moved forwards on the tiller shaft in order to engage a locking position of the handle, and can be moved backwards on the tiller shaft in order to engage the fourth engagement position of the handle.

In the first engagement position 9, the forward drive mode is engaged, which will rotate the propeller in a forward direction with a speed that is larger than the speed of the sailboat, such that the propeller will drive the boat forward. The first engagement position 9 is reached by rotating the handle 8 in a first, e.g. clockwise direction from the third engagement position when seen from the front of the handle, where the rotational position corresponds to a desired forward speed signal that is sent to the ECU. The handle may be spring-loaded such that the handle will return to the third engagement position if it is released. The handle may also be provided with a friction brake that holds the handle in the set rotational position. In this way, the handle can be released without affecting the forward speed of the sailboat. It is also possible to hold the handle in the actual rotational position by moving the handle in a in a longitudinal direction, e.g. forwards, to the locking position 13. In this position, the handle is locked in a rotational position and cannot be changed. In this way, a person must not hold the handle in a desired position for hours, which may be tiring.

In the second engagement position, the reverse drive mode is engaged, which will rotate the propeller in a reverse direction such that the propeller will drive the boat rearwards. The second engagement position 10 is reached by rotating the handle 8 in a second, e.g. counter-clockwise direction from the third engagement position when seen from the front of the handle, where the rotational position corresponds to a desired reverse speed signal that is sent to the ECU. The handle may be spring-loaded such that the handle will return to the third engagement position if it is released. The handle may also be provided with a friction brake that holds the handle in the set rotational position. It would also be possible to lock the handle in the actual rotational position by moving the handle in a second longitudinal direction, e.g. forwards, to the locking position 13. However, since a reverse direction is only used when docking or manoeuvring where the tiller must be operated at the same time, a locking of the second engagement position may not be necessary.

In the locking position, the handle is locked in the actual rotational position. By moving the handle in a second longitudinal direction, e.g. forwards, when in the third engagement position, i.e. when the electric drive system is in the idle drive mode, the idle drive mode is selected and the handle cannot accidentally be rotated to another engagement position. This locked position will be used when sailing. By moving the handle forwards to the locking position when the handle is in the first engagement position defining a desired forward speed of the sailboat, this desired speed will be selected and cannot be changed by accidentally rotating the handle or releasing the handle. This drive mode is useful when there is no wind and the sailboat must use the motor to move forwards.

In the fourth engagement position, the electric drive system is set in a hydro energy generation mode where the electric machine generates electricity to charge the battery. The fourth engagement position is reached by moving the handle in a first longitudinal direction, e.g. backwards, on the tiller, towards the stern of the sailboat. In the fourth engagement position, the other drive modes are disabled regardless of the rotational position of the handle.

In the hydro energy generation mode, the electric drive system is adapted to control the rotation of the propeller to a rotational speed that corresponds to a speed that is lower than the actual speed of the sailboat. In this way, the speed of the boat will force the propeller to rotate such that the electric machine will generate electricity to charge the battery. The ECU will control the induced charge current such that the rotation of the propeller reduces the speed of the sailboat by a predefined amount. The charge current is dependent on the rotational speed of the propeller and may be set in different ways. In one example, the charge current is set in dependence of the speed of the sailboat.

At a low speed, the charge current is set to a low value in order to minimize the drag of the propeller. At a higher speed, the charge current can be set to a higher value. At a low speed, e.g. between 1 to 4 knots, the charge current may be set to reduce the speed of the sailboat by e.g. a speed between 0.3 to 0.5 knots. At a high speed, e.g. between 5 to 8 knots, the charge current may be set to reduce the speed of the sailboat by e.g. a speed between 0.8 to 1.2 knots. The charge current may also be set in dependency of the actual state of charge of the battery. A low state of charge may set the charge current to a higher value, and a high state of charge may set the charge current to a low value, or may disconnect the electric machine completely, such that the battery is not charged at all. It is also possible to set the desired charge current in a menu system of the control system.

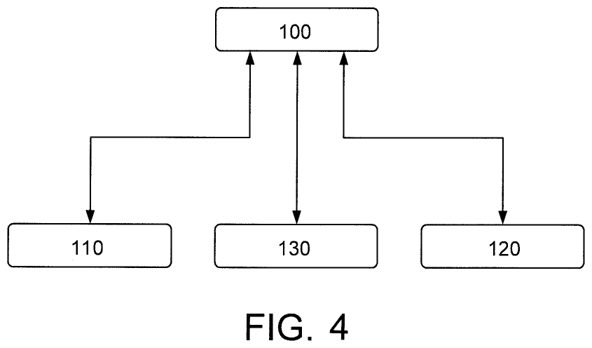

FIG. 4 shows a schematic flow chart of the method for engaging an electric drive system of a sailboat in different drive modes or a generation mode, where the drive modes or the generation mode are set by the use of a handle arranged on a tiller.

In step 100, the drive mode is an idle drive mode with the handle of the tiller in a third engagement position. In the idle drive mode, the propeller is either driven with a rotational speed that corresponds to the actual speed of the sailboat, such that the propeller does not induce any drag on the sailboat, or is disconnected from the electric machine such that the propeller can rotate freely.

In steps 110, the drive mode is a forward drive mode where the sailboat is driven forwards by the propeller. The forward drive mode is reached by turning the handle in a first, e.g. clockwise direction, and the desired speed is set by the rotational position of the handle. If the handle is spring-loaded, the handle will return to the third engagement position when the handle is released. If the handle is provided with a friction brake, the handle will remain in the selected rotational position until the handle is turned back to the third engagement position. It is also possible to lock the handle in the selected rotational position by pulling the handle forwards to a locking position.

In step 120, the drive mode is a reverse drive mode where the sailboat is driven rearwards by the propeller. The reverse drive mode is reached by turning the handle in a second, e.g. counter-clockwise direction, and the desired speed is set by the rotational position of the handle. If the handle is spring-loaded, the handle will return to the third engagement position when the handle is released. If the handle is provided with a friction brake, the handle will remain in the selected rotational position until the handle is turned back to the third engagement position.

In step 130, the electric drive system is in a hydro energy generation mode where the battery of the sailboat is charged by the electric machine driven by the propeller. The hydro energy generation mode is reached by moving the handle in a first longitudinal direction, e.g. rearwards, on the tiller. In the hydro energy generation mode, the ECU can control the propeller to rotate with a speed corresponding to a speed that is lower than the actual speed of the sailboat, such that the speed of the sailboat drives the propeller. The rotational speed of the propeller corresponds to a charge current to the battery. The ECU can control the charge current to a desired amount, depending e.g. on the actual speed of the sailboat or the state of charge of the battery.

The invention is not to be regarded as being limited to the embodiments described above, a number of additional variants and modifications being possible within the scope of the subsequent patent claims.

### REFERENCE SIGNS

1: Electric drive system
2: Tiller
3: Boat hull
4: Rudder
5: Electric machine
6: Drive unit
7: Propeller
8: Handle
9: First engagement position
10: Second engagement position
11: Third engagement position
12: Fourth engagement position
13: Locking position
14: Intermediate position
15: Electronic control unit
16: Battery
17: Bow
18: Stern
30: Sailboat

1. A tiller for controlling a rudder of a sailboat comprising a handle arranged to be controlled by one hand, where the handle is provided with a plurality of engagement positions, where a first engagement position is adapted to engage a forward drive mode of an electric drive system, a second engagement position is adapted to engage a reverse drive mode of the electric drive system, a third engagement position is adapted to engage an idle drive mode of the electric drive system, wherein the first engagement position is reached by rotating the handle in a first direction from the third engagement position, and the second engagement position is reached by rotating the handle in a second direction from the third engagement position wherein that a fourth engagement position is adapted to engage a hydro energy generation mode of the electric drive system, where the fourth engagement position is reached by moving the handle in a first longitudinal direction of the tiller, and in that the handle further comprises a locking position in which none of the engagement positions can be changed, where the locking position is reached by moving the handle in a second longitudinal direction of the tiller.

2. Tiller according to claim 1, wherein the first direction is a clockwise direction and the second direction is a counter-clockwise direction.

3. Tiller according to claim 1, wherein the first longitudinal direction is a rearward direction of the tiller.

4. Tiller according to claim 1, wherein the handle is provided with a friction brake adapted to hold the handle in the actual rotational position of the handle.

5. Electric drive system for a sailboat comprising a tiller according to claim 1, wherein the electric drive system further comprises an electric machine, a propeller, a battery and an electronic control unit.

6. Electric drive system according to claim 5, wherein the electric drive system is adapted to rotate the propeller with a rotational speed that corresponds to the speed of the sailboat, such that the propeller does not induce any drag, when the idle drive mode is engaged.

7. Electric drive system according to claim 6, wherein the electric machine is disconnected from the propeller by a clutch when the idle drive mode is engaged.

8. Electric drive system according to claim 5, wherein the electric drive system in the hydro energy generation mode controls the rotation of the propeller to a rotational speed that corresponds to a speed that is lower than the actual speed of the sailboat, such that the electric machine generates electricity to the battery.

9. Electric drive system according to claim 8, wherein the controlled rotation of the propeller reduces the speed of the sailboat with a speed between 0.3 to 1 knot.

10. Method for engaging an electric drive system of a sailboat in different drive modes, a generation mode, or a locking position in which none of the engagement positions can be changed, where the modes and locking position are set by the use of a handle arranged on a tiller, comprising the following steps:
engaging the electric drive system in an idle drive mode when the handle is in a third engagement position,
engaging the electric drive system in a forward drive mode by rotating the handle in a first direction from the third engagement position,
engaging the electric drive system in a reverse drive mode by rotating the handle in a second direction from the third engagement position,
engaging the electric drive system in a hydro energy generation mode by moving the handle in a longitudinal direction on the tiller, and
engaging a locking position by moving the handle in a second longitudinal direction of the tiller.

11. Sailboat, comprising a tiller according to claim 1.
